(19) United States
(12) Patent Application Publication
(10) Pub. No.: US 2019/0091706 A1
(43) Pub. Date: Mar. 28, 2019

(54) CAVITATION NOZZLE ASSEMBLY FOR SAND RECLAMATION UNIT

(71) Applicants: NEENAH FOUNDRY COMPANY, Neenah, WI (US); FURNESS-NEWBURGE, INC., Versailles, KY (US)

(72) Inventors: Tim Law, Neenah, WI (US); James C. Furness, JR., Versailles, KY (US)

(73) Assignees: NEENAH FOUNDRY COMPANY, Neenah, WI (US); FURNESS-NEWBURGE, INC., Versailles, KY (US)

(21) Appl. No.: 15/716,185

(22) Filed: Sep. 26, 2017

(51) Int. Cl. B05B 1/34; B02C 19/18; B02C 23/10; B22C 5/00

(52) U.S. Cl. CPC B05B 1/34; B22C 5/00; B02C 23/10; B02C 19/18

(57) ABSTRACT

A nozzle assembly for generating cavitation includes an inlet nozzle having a first end and an opposing second end. The inlet nozzle further includes an inlet bore extending from the first end to the second end, the inlet bore defining a first cross-sectional area at the first end and a second cross-sectional area at the second end. The second cross-sectional area is less than the first cross-sectional area, such that the inlet bore is configured to decrease pressure in a fluid from the first end to the second end, thereby forming vapor pockets in the fluid. The nozzle assembly further includes an outlet nozzle having a first end and an opposing second end. An outlet bore extends from the first end to the second end, the outlet bore configured to receive fluid from the inlet bore.

### TECHNICAL FIELD

The present application relates generally to, but is not limited to, the field of foundry sand reclamation. More specifically, the present application relates to a nozzle configured to induce cavitation in order to recover sand and clay that are bound together during the foundry process.

### BACKGROUND

During the foundry process, parts are cast in molds formed from molding sand. The sand defines a female mold shape, which is filled with molten metal (e.g., iron). When the molten metal is introduced to the mold, heat is transferred from the molten metal to the sand, firing (e.g., chemically bonding) and baking at least a portion of sand, forming a coating on the sand, and thereby generating hardened spent sand. Furthermore, sand may be held together by clay from the foundry process. This spent sand and clay must then be mixed with new molding sand before being used in a mold. For example, in order to maintain a desired ratio of new sand to spent sand, a portion of the spent sand is discarded after each casting process and replaced with the new molding sand. The spent sand and clay is typically discarded in a landfill, having a negative environmental impact.

Alternatively, a process for reclaiming the spent sand and clay includes incinerating the spent sand and clay. During the incineration process, the spent sand and clay is heated to a very high temperature, until the bond is broken down and the sand grains separate from each other. This process requires large fuel inputs and is therefore both costly to operate in order to generate sufficient heat, as well as subject to regulatory restrictions.

### SUMMARY

One embodiment relates to a nozzle assembly for generating cavitation, comprising an inlet nozzle having a first end and an opposing second end. The inlet nozzle further includes an inlet bore extending from the first end to the second end, the inlet bore defining a first cross-sectional area at the first end and a second cross-sectional area at the second end. The second cross-sectional area is less than the first cross-sectional area, such that the inlet bore is configured to decrease pressure in a fluid from the first end to the second end, thereby forming vapor pockets in the fluid. The nozzle assembly further includes an outlet nozzle having a first end and an opposing second end. An outlet bore extends from the first end to the second end, the outlet bore configured to receive fluid from the inlet bore.

Another embodiment relates to a method of isolating spent sand and clay from a foundry process, comprising receiving a mixture of spent sand, clay and water in an inlet nozzle of a nozzle assembly, and generating cavitation bubbles in the water. The method further includes collapsing at least a portion of the cavitation bubbles around the spent sand and clay and outputting energy from collapsing cavitation bubbles. The method further includes breaking apart at least a portion of the spent sand and clay with the energy from the collapsing cavitation bubbles, forming a separated sand and clay, and outputting the separated sand and clay.

As is discussed below, various embodiments disclosed herein provide for advantages such as by providing a sand and clay reclamation process that does not require excessive heat and breaks apart spent sand and clay for reintroduction to the foundry process.

### BRIEF DESCRIPTION OF THE DRAWINGS

FIG. 1 is an exploded view of a nozzle assembly, according to an exemplary embodiment.

FIG. 2 is a perspective view of the nozzle assembly of FIG. 1.

FIG. 3 is a cross-sectional view of the nozzle assembly of FIG. 1.

FIG. 4 is a perspective view of an orifice plate of the nozzle assembly of FIG. 1.

FIG. 5 is a perspective view of an outlet nozzle of the nozzle assembly of FIG. 1.

FIG. 6 is a schematic of a reclamation system, according to an exemplary embodiment.

### DETAILED DESCRIPTION

Referring to the figures generally, a nozzle assembly for generating cavitation is shown according to various embodiments. The nozzle assembly receives water carrying spent sand and clay therethrough and is configured to generate turbulent flow, lowering the pressure in water in order to four gas pockets. As pressure increases in the flow, the gas pockets collapse, causing cavitation in the water, breaking apart the spent sand and clay. The nozzle assembly will now be described in further detail.

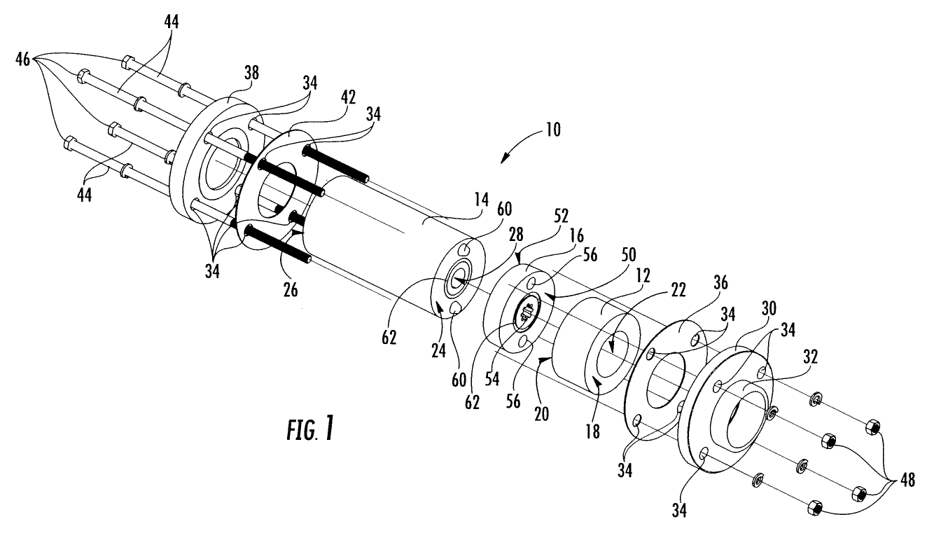

Referring now to FIG. 1, an exploded view of a nozzle assembly 10 (e.g., cavitation nozzle assembly) is shown according to an exemplary embodiment. The nozzle assembly 10 includes an inlet nozzle 12, an outlet nozzle 14, and an orifice plate 16 disposed between the inlet nozzle 12 and the outlet nozzle 14. The inlet nozzle 12 defines a first (i.e., upstream, inlet, etc.) end 18, an opposing second (i.e., downstream, outlet, etc.) end 20, and an inlet bore 22 extending therebetween. The outlet nozzle 14 defines a first (i.e., upstream, inlet, etc.) end 24, an opposing second (i.e., downstream, outlet, etc.) end 26, and an outlet bore 28 extending therebetween. The outlet nozzle 14 is configured to receive fluid (e.g., water mixed with spent sand and clay) from the inlet nozzle 12, through the orifice plate 16.

An inlet pipe flange 30 is disposed on the first end 18 of the inlet nozzle 12 and defines an inlet collar 32 extending axially outward from the nozzle assembly 10, the inlet collar 32 configured to receive and fluidly couple to PVC or other piping therein. For example, the inlet collar 32 of the inlet pipe flange 30 may define an inner diameter configured to receive 3 inch PVC piping when the nozzle assembly 10 is installed in a reclamation system, as will be discussed in further detail below. The inlet collar 32 is fluidly coupled to the inlet bore 22 and is configured to receive fluid therethrough and output the fluid to the inlet bore 22. The inlet pipe flange 30 defines a plurality of bolt bores 34 formed annularly about the inlet pipe flange 30. A first gasket 36 (e.g., O-ring) is disposed between the inlet pipe flange 30 and the first end 18 of the inlet nozzle 12. For example, the first gasket 36 may be compressed between the inlet pipe flange 30 and the inlet nozzle 12, such that the inlet pipe flange 30 sealingly engages the inlet nozzle 12. The first gasket 36 defines a plurality of bolt bores 34 formed annularly about the first gasket 36 and corresponding to and axially aligned with the bolt bores 34 of the inlet pipe flange 30.

Referring still to FIG. 1, an outlet pipe flange 38 is disposed on the second end 26 of the outlet nozzle 14 and defines an outlet collar 40 extending axially outward from the nozzle assembly 10, the outlet collar 40 configured to receive and fluidly couple to PVC or other piping therein. For example, the outlet collar 40 of the outlet pipe flange 38 may define an inner diameter configured to receive 3 inch PVC piping when the nozzle assembly 10 is installed in the reclamation system. The outlet collar 40 is fluidly coupled to the outlet bore 28 and is configured to receive fluid from the outlet bore 28 and to output the fluid to piping in a reclamation system. The outlet pipe flange 38 defines a plurality of bolt bores 34 formed annularly about the outlet pipe flange 38. A second gasket 42 (e.g., O-ring) is disposed between the outlet pipe flange 38 and the second end 26 of the outlet nozzle 14. For example, the second gasket 42 may be compressed between the outlet pipe flange 38 and the outlet nozzle 14, such that the outlet pipe flange 38 sealingly engages the outlet nozzle 14. The second gasket 42 defines a plurality of bolt bores 34 formed annularly about the second gasket 42 and corresponding to and axially aligned with the bolt bores 34 of both the inlet and outlet pipe flanges 30, 38 and the first gasket 36.

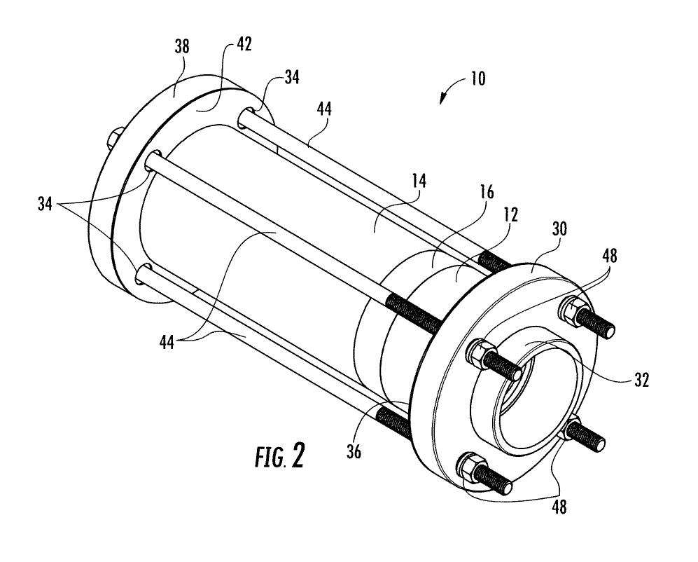

Referring now to FIG. 2, the nozzle assembly 10 is shown in an assembled configuration. The nozzle assembly 10 includes a plurality of bolts 44 or other fasteners extending through each of the bolt bore 34, from the inlet pipe flange 30 to the outlet pipe flange 38, coupling the inlet pipe flange 30 and the outlet pipe flange 38, and compressing the first and second gaskets 36, 42 to form a tighter seal. As shown in FIGS. 1 and 2, each bolt 44 defines a head 46 at a first end and a threaded second end configured to receive a nut 48. The head 46 engages (e.g., through a washer or a lock washer) one of the inlet pipe flange 30 or the outlet pipe flange 38, and the nut engages (e.g., through a washer or a lock washer) the other of the inlet pipe flange 30 or the outlet pipe flange 38. As the nut 48 is threaded further onto the bolt 44, the inlet and outlet pipe flanges 30, 38 are brought closer together and the first and second gaskets 36, 42 are further compressed into sealing engagement.

Referring again to FIG. 1, the orifice plate 16 defines a first (i.e., upstream, inlet, etc.) end 50 and an opposing second (i.e., downstream, outlet, etc.) end 52, with an orifice opening 54 extending therebetween. Each of the first and second ends 50, 52 defines a plurality dimples 56 (e.g., recesses) extending axially into the orifice plate 16 and formed annularly about the orifice plate 16. The inlet nozzle 12 defines a plurality of projections 58 extending axially from the second end 20, the projections 58 corresponding to and configured to be received in the plurality of dimples 56 on the first end 50 of the orifice plate 16. Similarly, the outlet nozzle 14 defines a plurality of projections 60 extending axially from the first end 24, the projections 60 corresponding to and configured to be received in the plurality of dimples 56 on the second end 52 of the orifice plate 16. While FIG. 1 shows the dimples formed in the orifice plate 16 and the projections 58, 60 formed on the inlet nozzle 12 and the outlet nozzle 14, respectively, it should be recognized that in other embodiments, projections may be formed on the orifice plate 16 and corresponding dimples may be formed in each of the inlet nozzle 12 and outlet nozzle 14. According to other embodiments, the orifice plate 16 may be axially aligned with the inlet nozzle 12 and the outlet nozzle 14 in other ways (e.g., keyed slot).

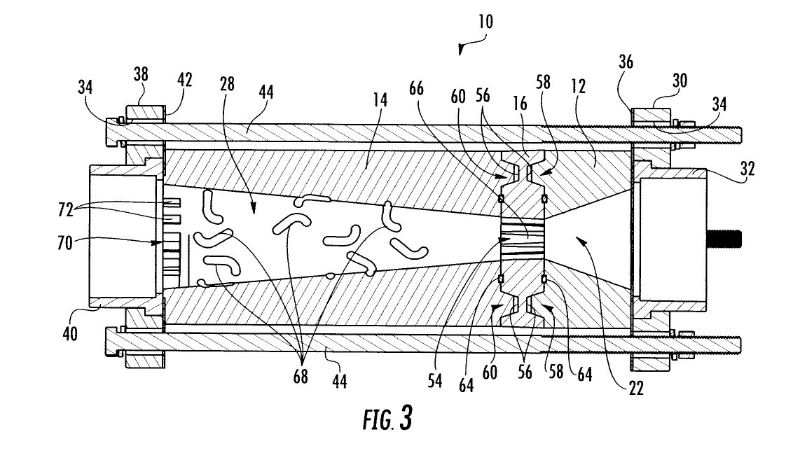

Each of the first and second ends 50, 52 may further define a sealing groove 62 formed annularly about the orifice opening 54. Complementary sealing grooves 62 may also be defined in the second end 20 of the inlet nozzle 12, formed annularly about the inlet bore 22, and the first end 24 of the outlet nozzle 14, formed annularly about the outlet bore 28. As shown in FIG. 3, O-rings 64 may be received in the sealing grooves 62 for compression between the orifice plate 16 and each of the inlet and outlet nozzles 12, 14, forming sealed engagement therebetween. While FIGS. 1-3 show the orifice plate 16 disposed between the inlet nozzle 12 and the outlet nozzle 14, according to other exemplary embodiments, the nozzle assembly 10 may be formed without an orifice plate, such that the inlet nozzle 12 is disposed on the outlet nozzle 14 or such that the inlet nozzle 12 and the outlet nozzle 14 are integrally formed.

Referring to FIG. 3, a cross-sectional view of the nozzle assembly 10 is shown. With respect to the inlet nozzle 12, the inlet bore 22 defines a first cross-sectional area A₁ at the first end 18 and a second cross-sectional area A₂ at the second end 20 that is substantially less than the first cross-sectional area A₁. FIG. 3 shows the inlet bore 22 forming a generally conical shape, converging moving from the first end 18 to the second end 20. By decreasing the cross-sectional area moving downstream, fluid (e.g., water carrying spent sand and clay) flowing from the first end 20 through the inlet nozzle 12 accelerates, thereby lowering the pressure in the fluid as it reaches the second end 20. The size of the first cross-sectional area A1 and the second cross-sectional area A₂ may be selected, such that pressure in the fluid proximate the second end 20 is low enough to form water vapor pockets (e.g., cavitation bubbles) in the fluid as it enters the orifice opening 54.

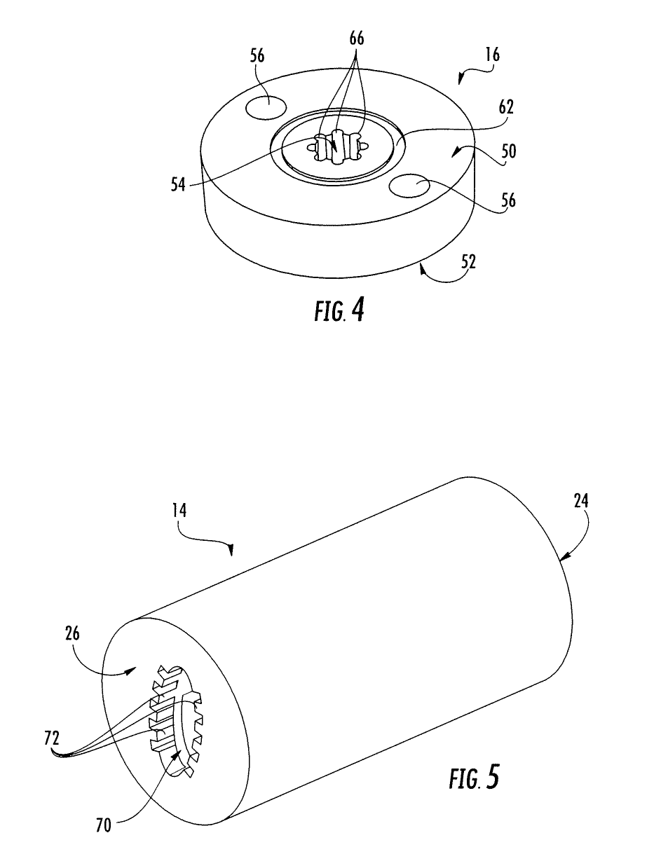

Referring to FIG. 4, the orifice plate 16 is shown according to an exemplary embodiment. The orifice opening 54 defines a generally florette-shaped profile formed by a plurality of grooves 66 at an outer periphery of the orifice opening 54. The profile is configured to increase turbulence in the fluid passing through the orifice opening 54. For example, the grooves 66 may follow a spiral pattern, thereby generating a vortex rotation in the fluid. The turbulence generated in the orifice opening 54 causes the formation of vapor pockets, generating cavitation.

Referring again to FIG. 3, with respect to the outlet nozzle 14, the outlet bore 28 defines a third cross-sectional area A₃ at the first end 24 and a fourth cross-sectional area A₄ at the second end 26 that is substantially greater than the third cross-sectional area A₃. FIG. 3 shows the outlet bore 28 forming a generally conical shape, widening moving from the first end 24 to the second end 26. By increasing the cross-sectional area moving downstream, fluid flowing from the first end 24 through the outlet nozzle 14 decelerates, thereby increasing the pressure (e.g., returning to its original pressure) in the fluid as it reaches the second end 26. The size of the first cross-sectional area A₃ and the second cross-sectional area A₄ may be selected, such that pressure in the fluid proximate the second end 26 is high enough to cause the water vapor pockets to collapse (i.e., implode), generating cavitation and releasing energy, causing the spent sand and clay in the fluid to break apart.

The outlet nozzle 14 further includes a plurality of recesses 68 formed in the outlet bore 28. As shown in FIG. 3, the recesses 68 define a generally “J” shape and are oriented in random directions to increase flow turbulence in the outlet nozzle 14 by redirecting flow moving past the recesses 68 as well as generate vapor pockets in the fluid. While FIG. 3 shows the recesses 68 having a “J” shape, according to other embodiments, the recesses 68 may include other shapes configured to redirect the flow. The outlet nozzle 14 may be formed by providing a male mold defining the desired pattern of recesses 68 and the shape of the outlet bore 28. The mold may be 3D printed and formed from silicone, such that it may be deformed and withdrawn from the outlet bore 28 after formation of the recesses 68.

Referring now to FIGS. 3 and 5, the outlet nozzle 14 is shown according to an exemplary embodiment. The outlet bore 28 defines an outlet opening 70 at the second end 26 of the outlet nozzle 14. The outlet opening 70 forms a generally elliptical shape, generating a substantially more planar distribution of the fluid and, more particularly, the vapor pockets. This change in distribution biases the vapor pockets away from the walls of the piping (e.g., conduits) affected by the nozzle, and minimizes the effects of cavitation on the piping itself by collapsing the vapor pockets closer to a centerline of the piping and away from the walls (e.g., surface) of the piping, where cavitation may damage (e.g., degrade) the piping. This configuration further reduces cavitation occurring close to the walls but away from spent sand and clay, thereby reducing the numbers of times the mixture of fluid and spent sand and clay must be passed through the nozzle assembly 10 and the overall cycle time. Referring still to FIG. 5, a plurality of fingers (e.g., teeth) 72 extend from the outlet opening 70, axially or at other angles inward into the outlet bore 28. These fingers 72 further induce turbulence in the fluid and generate vapor pockets proximate the outlet opening 70.

As the fluid carrying the spent sand and clay is passed through the outlet nozzle 14, the vapor pockets collapse in the outlet bore 28, generating cavitation. Furthermore, after the fluid is output from the nozzle assembly 10, remaining vapor pockets may collapse in the piping, generating cavitation outside of the nozzle assembly 10. As discussed above, when the vapor pockets collapse, energy is dispersed into the spent sand and clay. Small shockwaves cause the spent sand and clay to break apart into component parts of large and small grain sand particles, ceramic (e.g., originally lining the molding sand before introduction of molten metal to the mold), solidified metal material, and clay. These components may then be separated for reuse in the foundry process. It should be understood that cavitation may cause damage to the nozzle assembly 10. In order to improve the lifecycle of the nozzle assembly 10, at least portions of the nozzle assembly 10 may be formed from polyurethane or high-chromium alloys, configured to withstand cavitation.

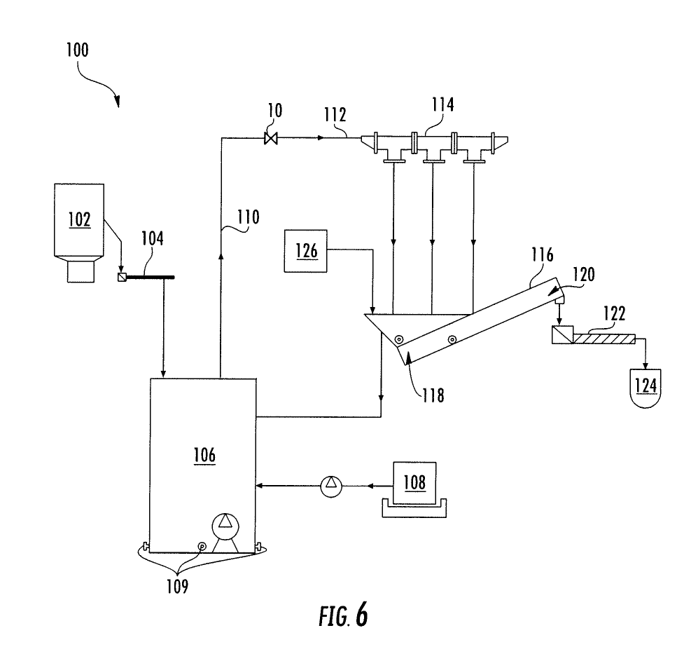

Referring now to FIG. 6, a reclamation system 100 is shown according to an exemplary embodiment. In the reclamation system 100, sand and clay from the foundry process is collected in a return sand hopper 102. When the reclamation system 100 has capacity to draw more sand in for processing, a screw conveyer 104 or other suitable system transfers a portion of the spent sand and clay in the return sand hopper 102 to a holding tank 106. Water is introduced to the holding tank 106 from a water supply 108 (e.g., tap water connection) and an agitator 109 (e.g., a plurality of compressed air pumps) in the holding tank 106 mixes the water and the spent sand, forming a water-sand mixture. The water-sand mixture may further include other sediments, including ceramic or clay from the foundry process, although the mixture is referred to herein as a “water-sand” mixture for simplicity purposes. The water-sand mixture is pumped from the holding tank 106 into a nozzle feed line 110, configured to supply the water-sand mixture to the nozzle assembly 10. The nozzle feed line 110 may be formed from 3 inch PVC piping or other suitable piping. For example, the piping may be configured to pass the water-sand mixture between 100 and 200 gpm, or at approximately 160 gpm.

The nozzle assembly 10 receives the water-sand mixture from the nozzle feed line 110 and as the water-sand mixture is passed through the nozzle assembly, the water in the mixture generates cavitation, breaking apart the sand in the mixture to isolate sand from ceramic, clay, and other sediments in the mixture. The cavitation may occur within the nozzle assembly 10 and/or downstream from the nozzle assembly 10 in a nozzle output line 112, configured to receive the fluid output from the nozzle assembly 10. The nozzle output line 112 passes over a plurality of sand settling tubes 114. The sand settling tubes 114 may include grates or other structures configured to allow water and isolated (e.g., separated) sand to pass through, while preventing larger sediments including ceramic and clay from passing therethrough. The water and isolated sand are supplied to a lower end 118 of an inclined dewatering screw 116 configured to separate sand from water and output isolated sand. The screw 116 is rotated, such that isolated sand is carried to an upper end 120 of the screw 116 and the water remains proximate the lower end 118. The isolated sand is then carried away from the screw 116 on a conveyer 122 (e.g., screw conveyer, belt conveyer, etc.) to a cooler 124 (e.g., Hartley cooler) for cooling the isolated sand. For example, the sand may be introduced to the reclamation system 100 at an elevated (e.g., above ambient) temperature due to heat transferred to the sand from the foundry process. Once the sand is isolated, it can be reused in the foundry process as new (e.g., reclaimed, fresh, isolated, separated) sand or may be exported from the reclamation system 100 for other purposes (e.g., sold). In some embodiments, if more water and isolated sand are fed from the sand settling tubes 114 to the dewatering screw 116 than the dewatering screw 116 has capacity to process, at least a portion of the water and isolated sand may overflow to the holding tank 106. Further, if additional water is needed at the dewatering screw 116, water may be supplied from the holding tank 106, from the water supply (i.e., first water supply) 108 or from a separate second water supply 126.

Remaining sand, water, and other sediments may pass over other collection tanks for removing ceramic, clay, or other sediments. These collection tanks may separate sediment in a substantially similar way to the sand settling tubes 114. Any sand, water, and clay in the nozzle output line 112 that is not separated is then returned to the holding tank 106 for reintroduction to the nozzle assembly 10 through the nozzle feed line 110. In this configuration, the water-sand mixture may recirculate through the reclamation system 100 until substantially all of the sand or other sediments are recovered. Accordingly, in the reclamation system 100 land fill waste can be substantially reduced or eliminated.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, dimensions, structures, shapes and proportions of the various elements, mounting arrangements, use of materials, orientations, manufacturing processes, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A nozzle assembly for generating cavitation, comprising:
an inlet nozzle comprising:
a first end;
an opposing second end; and
an inlet bore extending from the first end to the second end, the inlet bore defining a first cross-sectional area at the first end and a second cross-sectional area at the second end;
wherein the second cross-sectional area is less than the first cross-sectional area, such that the inlet bore is configured to decrease pressure in a fluid from the first end to the second end, thereby forming vapor pockets in the fluid; and
an outlet nozzle comprising:
a first end;
an opposing second end; and
an outlet bore extending from the first end to the second end, the outlet bore configured to receive fluid from the inlet bore.

2. The nozzle assembly according to claim 1, further comprising an orifice plate disposed between the second end of the inlet nozzle and the first end of the outlet nozzle, the orifice plate defining an orifice opening configured to receive the fluid from the inlet nozzle and output the fluid to the outlet nozzle.

3. The nozzle assembly according to claim 2, wherein the orifice opening defines a plurality of grooves at an outer periphery thereof, the plurality of grooves defining a florette profile.

4. The nozzle assembly according to claim 2, wherein the orifice plate defines a first end configured to engage the second end of the inlet nozzle, and an opposing second end configured to engage the first end of the outlet nozzle, and further comprising:
a first O-ring disposed between and sealingly engaging the second end of the inlet nozzle and the first end of the orifice plate; and
a second O-ring disposed between and sealingly engaging the second end of the orifice plate and the first end of the outlet nozzle.

5. The nozzle assembly according to claim 1, further comprising:
an inlet pipe flange disposed on the first end of the inlet nozzle, the inlet pipe flange defining an inlet collar configured to receive a water-sand mixture from a sand reclamation system and to output the fluid to the inlet bore; and
an outlet pipe flange disposed on the second end of the outlet nozzle, the outlet pipe flange defining an outlet collar configured to receive fluid from the outlet bore and output the water-sand mixture to the sand reclamation system.

6. The nozzle assembly according to claim 5, further comprising:
a first gasket disposed between and sealingly engaging the inlet pipe flange and the inlet nozzle; and
a second gasket disposed between and sealingly engaging the outlet nozzle and the outlet pipe flange.

7. The nozzle assembly according to claim 6, wherein each of the inlet pipe flange, the first gasket, the second gasket, and the outlet pipe flange define a plurality of corresponding bolt bores extending therethrough, the bolt bores configured to receive bolts therein; and
wherein the inlet pipe flange, the first and second gaskets, and the outlet pipe flange are coupled with the bolts, such that the first and second gaskets are compressed.

8. The nozzle assembly according to claim 1, further comprising a plurality of recesses formed in the outlet bore, the plurality of recesses configured to form the vapor pockets in the fluid.

9. The nozzle assembly according to claim 1, further comprising an outlet opening at the second end of the outlet nozzle and a plurality of fingers extending from the outlet opening inward into the outlet bore, the plurality of fingers configured to form the vapor pockets in the fluid.

10. The nozzle assembly according to claim 1, wherein the outlet bore defines a third cross-sectional area at the first end and a fourth cross-sectional area at the second end greater than the third cross-sectional area.

11. A method of isolating spent sand and clay from a foundry process, comprising:
receiving a mixture of spent sand, clay, and water in an inlet nozzle of a nozzle assembly;
generating cavitation bubbles in the water;
collapsing at least a portion of the cavitation bubbles around the spent sand and clay and outputting energy from collapsing cavitation bubbles;
breaking apart at least a portion of the spent sand and clay with the energy from the collapsing cavitation bubbles, forming a separated sand and clay; and
outputting the separated sand and clay.

12. The method of claim 11, wherein the inlet nozzle comprises:
a first end;
an opposing second end; and
an inlet bore extending from the first end to the second end, the inlet bore defining a first cross-sectional area at the first end and a second cross-sectional area at the second end;
wherein the second cross-sectional area is less than the first cross-sectional area, such that the inlet bore is configured to decrease pressure in the mixture from the first end to the second end, thereby forming the cavitation bubbles in the mixture.

13. The method of claim 12, wherein the nozzle assembly further comprises an outlet nozzle comprising:
a first end;
an opposing second end; and
an outlet bore extending from the first end to the second end, the outlet bore defining a third cross-sectional area at the first end and a fourth cross-sectional area at the second end;
wherein the outlet bore is configured to receive the mixture from the inlet bore; and
wherein the fourth cross-sectional area is greater than the third cross-sectional area, such that the outlet bore is configured to increase pressure in the mixture from the first end to the second end, thereby collapsing the cavitation bubbles in the mixture.

14. The method of claim 11, further comprising outputting at least a portion of the cavitation bubbles from an outlet nozzle of the nozzle assembly.

15. The method of claim 11, further comprising recirculating water and spent sand output from an outlet nozzle of the nozzle assembly into the inlet nozzle.
